(19) United States
(12) Patent Application Publication
(10) Pub. No.: US 2008/0276264 A1
(43) Pub. Date: Nov. 6, 2008

(54) Certified two way source initiated transfer

(76) Inventors: Mats A. Selen, Tuscola, IL (US); Timothy J. Stelzer, Urbana, IL (US)

Correspondence Address: Olson & Cepuritis, LTD., 20 NORTH WACKER DRIVE, 36TH FLOOR, CHICAGO, IL, 60606, US

(21) Appl. No.: 12/217,541

(22) Filed: Jul. 7, 2008

Related U.S. Application Data
(63) Continuation of application No. 11/593,883, filed on Nov. 7, 2006.

(51) Int. Cl. H04H 60/33

(52) U.S. Cl. 725/13

(57) ABSTRACT

An audience response system comprising a base unit and a plurality of remote units communicating using wireless communication operating on a frequency pair. When a response key on a remote unit is activated, the remote unit transmits a voting signal packet to the base unit. The base unit registers the vote and transmits an acknowledgment signal to the remote unit. When the remote unit receives an acknowledgment signal, the remote unit certifies to the operator that the vote was received. If an acknowledgment signal is not received, the remote unit will attempt at least one retransmission after a random delay before alerting the operator that the vote attempt has failed.

### CROSS-REFERENCE TO RELATED APPLICATIONS

This application is a continuation of application Ser. No. 11/593,883, filed Nov. 7, 2006 by Mats A. Selen and Timothy J. Stelzer, which is hereby incorporated by reference in its entirety.

### FIELD OF INVENTION

This invention relates to wireless audience response systems. In particular, this invention relates to the a system for receiving the responses of a plurality of remote units without the need for a base unit initiated polling signal.

### BACKGROUND OF INVENTION

The present invention is directed to a wireless audience response system. The system is typically used in a classroom setting, but can be readily adapted to use in any setting where audience opinion polling is of interest. The audience response system includes a base unit accessible to the facilitator and a number of remote units distributed to members of the audience. The base unit is capable of obtaining responses from the remote units operated by the audience members. The facilitator can solicit feedback from or survey the audience by asking a question. Audience members then cast their votes by pressing one of several keys. The votes are collected at the base unit where the results are made available to the facilitator.

Existing audience polling systems retrieve the vote from each remote unit using a protocol of base initiated polling. In base initiated polling, the vote cast by the operators of the remote units are stored in the memory of the remote units until the base unit transmits a command signal instructing remote units to communicate their votes to the base unit. Remote units transmit their stored votes in response to the command signal from the base unit. There are several ways of controlling the flow of responses to the polling command. The command signal can take the form of a global command that commands all remote units within receiving range to transmit within a predetermined time slice unique to each remote unit, such as disclosed in U.S. Patent Application Publication 2003/0215780 to Saar et al. The base unit from still other systems poll remote units individually in sequence by broadcasting a command signal addressed to an individual remote unit. Such a system is disclosed in U.S. Pat. No. RE 35,449 to Derks.

A characteristic of base initiated polling systems is that the remote unit does not send the vote until requested to by the base unit. This can cause a delay in vote collection if the user of a given remote unit has not yet voted by the time the remote unit is polled to transmit its stored vote, particularly with large numbers of remote units.

Another attendant problem in existing audience response systems is the lack of signal acknowledgment and the lack of feedback to the operator of a remote unit. After a remote unit transmits its vote, the holder of the remote unit may not know whether the vote was received and registered by the base unit. In the event that multiple remote units transmit simultaneously, the resulting signal collision can lead to the base unit receiving none of the attempted votes. The occurrence of these failed vote transmissions are not readily apparent to the member of the operator of the remote unit.

What is needed is a system for surveying an audience response that eliminates the use of base initiated polling and provides feedback on the status of the vote to the users of the remote unit. The present invention meets these desires and overcomes the shortcomings of the prior art.

### SUMMARY OF THE INVENTION

The present invention is an audience response system comprising a base unit and a plurality of remote units communicating wirelessly on a pair of frequencies. The remote units and the base unit operate on a pair of frequencies in that transmissions from the base unit to the remote unit occur on one frequency while transmissions from the remote unit to the base unit occur on a second frequency. The frequency pairs chosen are configurable to permit operation of multiple audience response systems in close proximity on different frequency pairs without the risk of interference.

Each remote unit is associated with a unique identification code and comprises a plurality of response keys that can be activated by the operator of the remote unit to cast a vote. Each remote unit also includes a remote transmitter and a remote receiver, and at least one counter for use in generating a random delay for retransmitting the vote signal packet.

When a response key on a remote unit is activated, the remote unit transmits a vote signal packet to the base unit. The base unit registers the vote and transmits an acknowledgment signal to the remote unit. When the remote unit receives an acknowledgment signal, the remote unit certifies to the operator that the vote was received. If an acknowledgment signal is not received, the remote unit will attempt at least one retransmission after a random delay before alerting the operator that the vote attempt has failed.

The transmission of a vote signal packet may not be received properly by the base unit in the event of signal interference or collision with the simultaneous transmission of a vote signal packet from a second remote unit. If the remote unit does not receive an acknowledgment signal, it attempts to retransmit the vote signal packet after a random delay. The duration of the delay is dependent on the state of a resetting counter in the remote unit. Since the retransmission is delayed until the next counter reset, the probability that two remote units will simultaneously retransmit is reduced since it is unlikely that respective counters are simultaneously in the same state.

### BRIEF DESCRIPTION OF THE DRAWINGS

In the drawings,

FIG. 1A is an overview of a preferred embodiment of the audience response system in accordance with the present invention;

FIG. 1B is a schematic of the base unit and the remote unit of FIG. 1A;

FIG. 2 is a perspective drawing of the remote unit of FIG. 1A;

FIG. 3 is a flowchart illustrating the operation of the first counter and the second counter of the remote unit;

FIG. 4 is an illustration showing the changing states of the first counter and second counter of the remote unit with the passive of time;

FIG. 5 is a chart showing the role of the first counter and the second counter of the remote unit in the timing of repeated vote signal packet transmission attempts;

FIG. 6 is an illustration depicting an example where the first counter is used to resolve a signal collision between two remote units that initially transmit at the same time;

FIG. 7 is an illustration depicting an example where the first counter and the second counter are used to resolve a signal collision between two remote units that initially transmit at the same time; and

FIG. 8 is a chart showing the functional operation of the base unit.

### DESCRIPTION OF THE PREFERRED EMBODIMENTS OF THE PRESENT INVENTION

The invention disclosed herein is susceptible to embodiment in many different forms. The embodiments shown in the drawings and described in detail below is only for illustrative purposes. The disclosure is intended as an exemplification of the principles and features of the invention, but does not limit the invention to the illustrated embodiments.

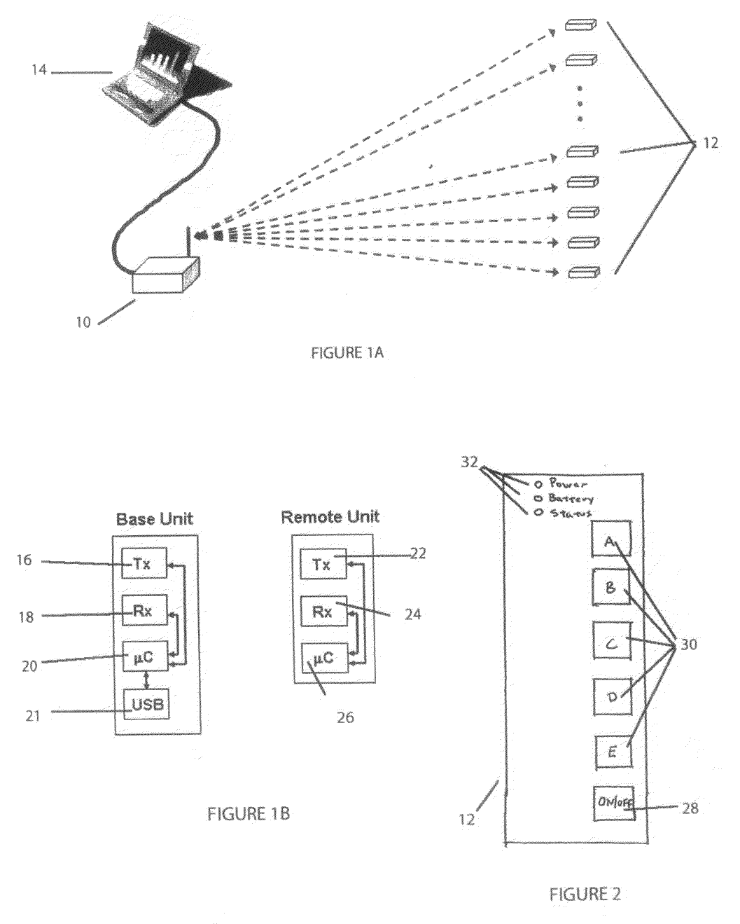

Referring to FIGS. 1A and 1B, a preferred embodiment of the audience response system according to the present invention is shown. The system comprises a base unit 10 and a plurality of remote units 12. The base unit 10 may be connected to a personal computer 14 that controls the functionality of the base unit 10 and displays the results collected from remote units 12.

The base unit 10 comprises a base transmitter 16 for transmitting signals and a base receiver 18 for receiving signals. The base transmitter 16 and the base receiver 18 are controlled by a microprocessor 20. The base unit 10 may also have a communications port 21 such as a universal serial bus port, IEEE 1394, parallel port, or other communications interface for interaction between the base unit 10 and a computer. In a preferred embodiment, the base transmitter 16 and the base receiver 18 operate on a pair of radio frequencies in the 900 MHz band. It should be understood that the functions of the base transmitter 16 and the base receiver 18 can be combined into a transceiver. It should also be recognized that the system can be adapted to operate on different frequency bands or using other means of wireless communication such as infrared or microwave.

As previously described, the base unit 10 preferably communicates with a personal computer 14 that may be separately connected or integrated with the base unit 10. In a preferred embodiment, the base unit 10 and the personal computer 14 are connected by a universal serial bus interface, but it is understood that other connections can be readily substituted.

Each remote unit 12 contains a remote transmitter 22 and a remote receiver 24 controlled by a processor such as a microprocessor 26. It should be understood that the function of remote transmitter 22 and remote receiver 24 can be combined into a single transceiver. The remote transmitter 22 and the remote receiver 24 can be powered by an removable power source such as a battery (not shown).

The remote unit 12 as shown in FIG. 2 includes a power switch 28 and a plurality of response keys 30. In one preferred embodiment, each remote unit contains five response keys 30, labeled A, B, C, D, and E respectively. The remote unit further includes several status indicators 32. The status indicators 32 are preferably LEDs or other visual signals and are used to indicate to an operator whether the remote unit 12 is powered on, has a low battery, draw attention to a warning or status. The status indicators 32 may also take the form of LCDs or other graphical displays to communicate textual or graphical information to the operator of the remote unit. The status indicators 32 may also take the form of indicators that provide audio cues other attention gathering devices.

Each remote unit 12 has a predetermined identification address that is unique to the remote unit. This identification address may be hardcoded into the remote unit 12 or may be configurable by the operator of the remote unit 12, such as by a series or combination of response keys 30. This identification address is used to distinguish the one remote unit from another remote unit. It is readily apparent that the longer the length of the identification address, the more unique remote units can be supported by a base system. For example, if twenty one bits are used to create a remote unit identification address, there are 2,097,152 unique identification addresses available. Similarly, a system where only ten bits of data are used for the remote unit identification address will only support 1,024 remote units. It is contemplated that the remote units 12 and the base unit 10 are provided together as a system. However, the remote units 12 and the base unit 10 may be packaged and provided separately for use.

Preferably, communication between a base unit 10 and a remote unit 12 takes place on a pair of radio frequencies. Signals from base transmitter 16 are transmitted and received by remote receiver 24 on a first frequency fA, while signals from the remote transmitter 22 are transmitted and received by the base receiver 18 on a second frequency fB. In other words, all transmissions in the direction from the base to the remote units are carried on frequency fA, while all transmissions from the remote units to the base unit are carried on frequency fB. By separating the transmission and receiving frequencies, signal collisions are reduced while bandwidth and system performance are improved.

The system can also be configured to operate on one of a plurality of frequency pairs. The frequency pair for which a base unit is set to operate on can be altered by a command from the computer 14. Remote units can be instructed to operate on different frequency pairs by using a combination of key presses with the power key 28 and/or response keys 30. In a preferred embodiment, this can be accomplished by a user holding the power key 28 for an extended period of time followed by entering a pair of response keys 30 to indicate the desired frequency pair for operation. By setting multiple audience response systems to operate on different frequency pairs, multiple systems can be used in close proximity to each other without interfering with nearby systems.

Each remote unit 12 further includes at least one counter, preferably a first counter and a second counter. A timer or timing circuit may also be present to assign the discrete timing intervals as described. These counters are initialized when the remote unit 12 is first powered on. In a preferred embodiment, the first counter counts down from a value of four to one while the second counter counts down from a value from five to one in integer steps every ten milliseconds. After a counter reaches one the next step takes it back to its initial value. Preferably, the first counter and the second counter differ in the number of steps per cycle. It will be readily apparent that the number of steps per cycle for the first counter, the number of steps per cycle for the second counter, and the time interval between each step can be varied as desired.

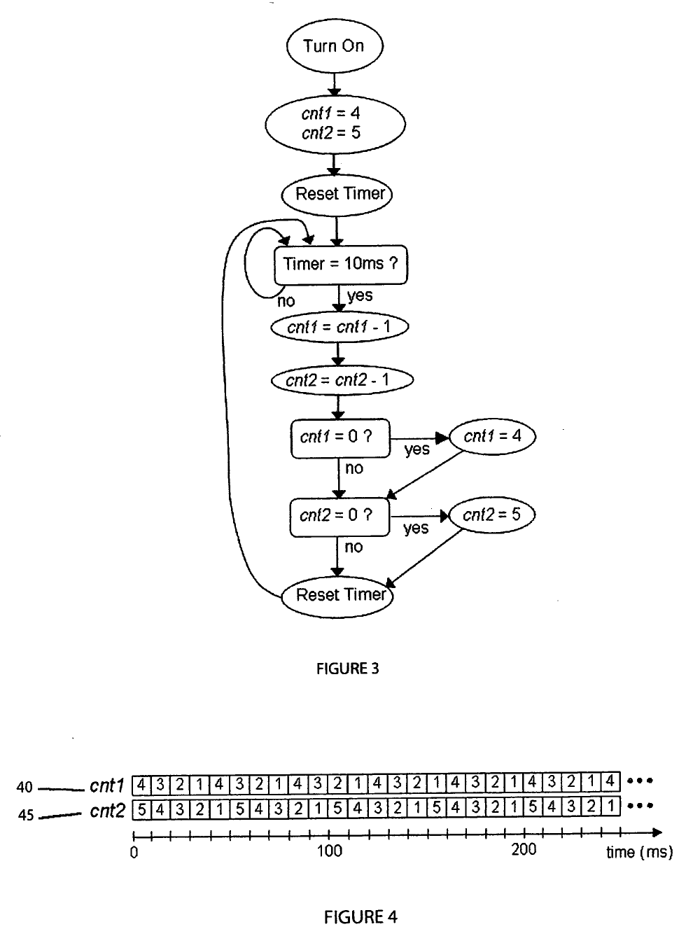

The logical flowchart of the counter operation is shown in FIG. 3 for a first counter with four discrete states and a second counter with five discrete states cycling at ten millisecond intervals. When the remote unit 12 is turned on, the first counter is initialized to a value of four and the second counter is initialized to a value of five. After ten milliseconds has passed on the timer, the value of the first counter and the second counter are each decreased by one. If the value of either counter reaches zero, the corresponding counter is reinitialized. This cycle continues until the remote unit 12 is powered off.

The state of the first counter 40 and the state of the second counter 45 as a function of time is shown in FIG. 4. At time=0 when the remote unit 12 is powered on, the first counter 40 is initialized to a state of four and the second counter 45 is initialized to a state of five. When the first counter 40 and the second counter 45 differ in the number of steps per cycle, a number of state combinations will result. As shown in FIG. 4, the use of four states on the first counter 40 and five states on the second counter 45 produce twenty distinct state combinations before repeating. These state combinations are used by the remote unit 12 to determine the amount of time to delay before attempting to retransmit a failed transmission as described below.

The audience response system can be deployed in a situation where audience feedback is desired. As an example, the system can be deployed in a classroom lecture setting, where each student is provided with a remote unit 12. The instructor can then obtain audience feedback by requesting that students vote on one of several choices. As described below, the votes are tabulated by the base unit and made available for review by the instructor. The instructor can thus obtain realtime feedback. Similarly, the audience response system can also be deployed in the context of any situation where soliciting audience feedback is desired.

The operation of the voting process in a preferred embodiment will now be described. When the base unit is commanded into an acquisition mode, the normal state of the base unit 10 is to passively listen for voting signals from remote units 12. When feedback is required from the audience, the audience member or operator activates one of the response keys 30 on their remote unit 12. In response to the key activation, the remote unit 12 assembles a vote signal packet that includes the remote unit's unique identification code, the vote corresponding to the response key activated on the remote unit, and a checksum. The remote unit 12 then powers on the remote transmitter 22, transmits the vote signal packet to the base unit 10 on frequency fB, and powers down the remote transmitter 22. The vote signal packet is received by the base receiver 18 on frequency fB and processed by the base unit 10.

After the base unit 10 registers the vote from the transmitting remote unit, the base unit 10 powers on the base transmitter 16, transmits an acknowledgment signal to the remote unit 12 on frequency fA, and powers down the base transmitter 16. The acknowledgment signal is composed of the same vote signal packet that was received, but may take other forms. The acknowledgment signal is received by the remote receiver 24 on frequency fA by all remote units in range which have their receivers activated. Since the acknowledgment signal transmitted by the base unit is identical to the vote signal packet sent by the remote unit, the acknowledgment signal includes the transmitting remote unit's unique identification code. By comparing the remote unit's unique identification code to the identification code contained in the acknowledgment signal, remote units can ignore messages that do not contain a matching identification code. The transmitting remote unit, upon receiving an acknowledgment signal containing a matching identification code, certifies to the operator of the remote unit that the vote has been registered through the status indicator 32, for example by visually displaying a green light or displaying a message such as “Vote Received” on the LCD. In this way, the operator of the transmitting remote unit 12 is informed that the vote was successfully transmitted, received, and counted by the base unit.

Occasionally, particularly when large numbers of remote units are deployed, a situation may arise where two or more remote units attempt to transmit their vote signal packets at the same time. In this situation, it is possible that the base unit will not clearly receive a vote signal packet due to collisions or interference from multiple incoming signals. When the base unit receives an invalid vote signal packet, the base unit takes no action. As a result, none of the transmitting remote units receive an acknowledgment message.

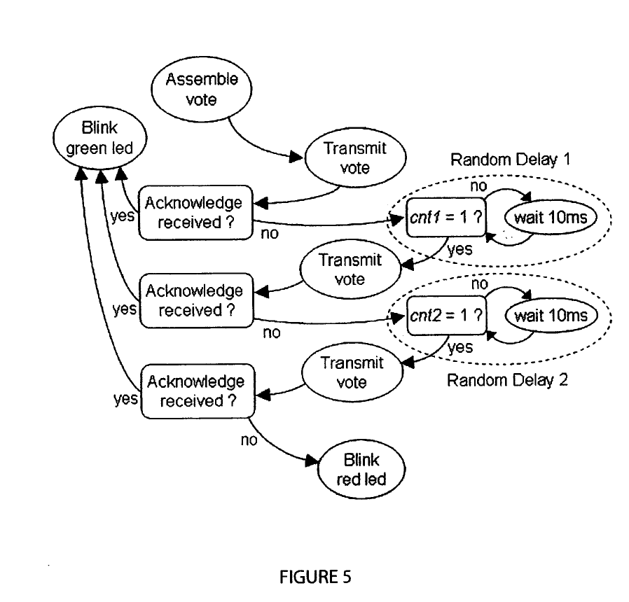

When this occurs, each remote unit will attempt to retransmit the message, with a variable delay before each retransmission attempt based on the value of the first counter 40 and the second counter 45 in the remote unit 12. This process is illustrated in FIG. 5, with the first counter 40 denoted as cnt1 and the second counter 45 denoted as cnt2. After the initial attempt to transmit the vote signal packet fails, each remote unit will attempt to retransmit the message when the state of the first counter reaches a value of one. Since the counter for each remote unit is initialized when the unit is powered on, it is likely that the counters are not in phase and will attempt the first retransmission at different time slots.

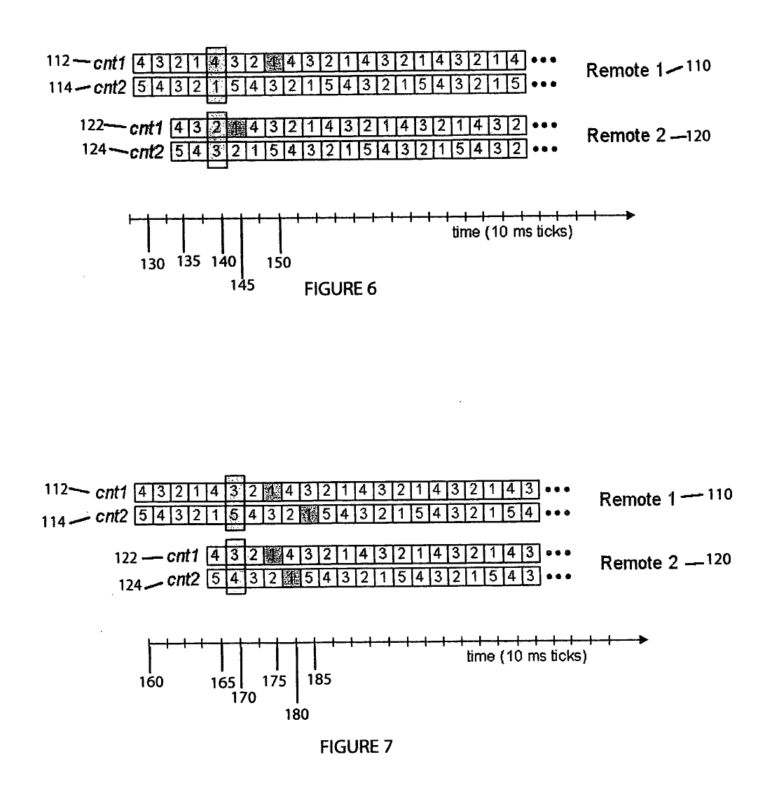

An example of this process is shown in the context of FIG. 6 with respect to two remote units, a first remote unit 110 and a second remote unit 120. The first remote unit 110 includes two counters, a first counter 112 and a second counter 114. Similarly, the second remote unit 120 includes a first counter 122 and a second counter 124. The first remote unit 110 is powered on at time 130 and initializes the first counter 112 to a value of four. The second remote unit 120 is powered on at a later time 135 and initializes the first counter 122 to a value of four. At the same time 135, the state of the first counter 112 on the first remote unit 110 has been decreased to two.

At time 140, the operators of the first remote unit 110 and the second remote unit 120 simultaneously press a response key to trigger a vote. Since the votes are cast simultaneously, the vote signal packets interfere with each other and are not received by the base unit. When the first remote unit 110 and the second remote unit 120 do not receive an acknowledgment signal from the base unit, the remote units 110 and 120 attempt to retransmit their respective vote signal packets based on the value of the first counter 112 and 122 respectively. Specifically, the retransmission attempt by the first remote unit 110 and the second remote unit 120 occurs when the first counters 112 and 122 of the respective units reaches a value of one. As shown in the example of FIG. 6, this occurs first at time 145 for the second remote unit 120 and at a later time 150 for the first remote unit 110. Since the first counter 112 of the first remote unit 110 is out of phase with the first counter 122 of the second remote unit 120, each remote unit is able to successfully retransmit their votes without interfering with each other.

In the event that the initial transmission attempt and the first retransmission attempt both fail, the remote units 110 and 120 will attempt to a second retransmission of the vote signal packet based on the value of the second counters 114 and 124 respectively. An example of this process is illustrated in FIG. 7. At time 160, the first remote unit 110 is powered on, initializing the first counter 112 to a value of four and the second counter 114 to a value of five. At time 165, the second remote unit 120 is powered on, initializing the second remote unit's first counter 122 to a value of four and the second counter 124 to a value of five. Each of the counters 112, 114, 122, and 124 decrement by one with each ten millisecond time increment, resetting to their initial value each time the counter decrements from a value of one.

At time 170, operators of the first remote unit 10 and the second remote unit 120 simultaneously press the response keys to initiate a vote. Since they are temporally simultaneous, the vote signal packets from one unit interferes with the other and no signal is received by the base unit. Without an acknowledgment signal, both units attempt to retransmit based oh the value of the first counter 112 and 122 respectively as described above in conjunction with FIG. 6. In this example, the state of the first counters 112 and 122 on the first remote unit 110 and the second remote unit 120 respectively both reach a value of one at time 175. Contrasted to the successful retransmission attempt shown in FIG. 6, the first retransmission attempt at time 175 fails due to the simultaneous retransmission. The remote units then attempt a second retransmission based on the value of the second counters 114 and 124 respectively. At time 180, the value of the second counter 124 on the second remote unit 120 reaches one and the vote signal packet from the second remote unit 120 is transmitted. Contrastingly, the second counter 114 of the first remote unit 110 does not reach a value of one until subsequent time 185. Consequently, both remote units 110 and 120 are able to successfully complete transmission of their respective vote signal packets without interference with each other.

It will be appreciated that while rare, it is possible that a vote signal packet is initiated from two remote units simultaneously and the first counter and second counter of both remote units are in phase. This will result in a failure of the initial transmission attempt and each of the two subsequent retransmission attempts due to signal collision and interference. Repeated transmission failure can also occur for other reasons, such as if the remote unit is not within range of a base unit on the same frequency pair or a device malfunction. The operator of the remote unit is provided with a feedback signal through status indicator 32 that the vote transmission was not successful. After the retransmission attempts have been exhausted, an indication is displayed to the operator of the remote unit to signal that all transmission attempts have failed. For example, a flashing red light can be displayed on the status indicator 32 to inform the operator that the vote was not properly registered and should be recast. Subsequent collisions between the two remote units are unlikely to occur unless the operators again vote simultaneously and both counters on each respective remote unit are in phase.

It is readily apparent that additional counters can be added to create additional retransmission cycles and minimize the risk of collision and transmission failure. It is also apparent the risk of signal collisions can be reduced by altering the range over which the counters decrement. While for purposes of illustration the value of the first counter ranges from four to one and the value of the second counter ranges from five to one, it should be appreciated that those ranges can be expanded to increase the number of distinct state combinations, further reducing the probability that the first or second counters of one remote unit is in phase with the corresponding counter of the second remote unit at any given time. In one preferred embodiment, the range of the counters may be configured by the operator of the remote unit such as through the use of a combination of response keys 30.

The normal operating state of a remote unit 12 is preferably to passively wait for the operator to activate one of the response keys 30. While in this state, the remote transmitter 22 and the remote receiver 24 are in a passive state. When the remote unit 12 detects that a response key 30 has been activated, the remote unit microprocessor 26 assembles a vote signal packet that includes the vote corresponding to the response key 30 pressed and the unique identification code of the remote unit. The remote unit 12 then activates the remote transmitter 22 and transmits the vote signal packet to the base unit 10. After the transmission is complete, the remote unit 12 powers down the remote transmitter 22 and activates the remote receiver 24 to await an acknowledgment message from the base unit 10. If the base unit 10 successfully received the vote signal packet, the base unit broadcasts an acknowledgment signal that includes the unique identification code of the remote unit contained in the vote signal packet. Since the acknowledgment signal includes the unique identification code of the transmitting remote unit, the acknowledgment signal indicates that the vote was received. On receipt of the acknowledgment signal, the remote unit 12 indicates to the operator that the vote was received by means of status indicator 32, such as flashing a green light, and powers down the remote receiver 24. This certifies to the operator of the remote unit 12 that the vote was successfully received.

If the remote unit 12 does not receive an acknowledgment signal from the base unit 10, the remote unit 12 waits for an interval of time dependent on the state of the first counter 112 before transmitting the vote signal packet again and waiting for an acknowledgment signal to be returned. If no acknowledgment signal is returned, the remote unit waits another interval of time dependent on the state of the second counter 114 before transmitting the vote signal packet a third and final time. If after the third transmission attempt no acknowledgment signal is returned, the remote unit indicates to the operator that the transmission failed by means of the status indicator 32, such as by flashing a red light. This informs the operator that the vote was not received and should be recast.

A remote unit thus attempts to send a given vote to the base unit up to three times, with a variable random delay between each transmission attempt. If a transmission attempt is successful, a green light is displayed to certify to the operator that the vote was received. If no acknowledgment signal is received after all three attempts, a red light is displayed to inform the operator that the vote was not registered by the base unit. The operator thus receives feedback and is aware of whether the operator's vote was successfully received and counted by the base unit.

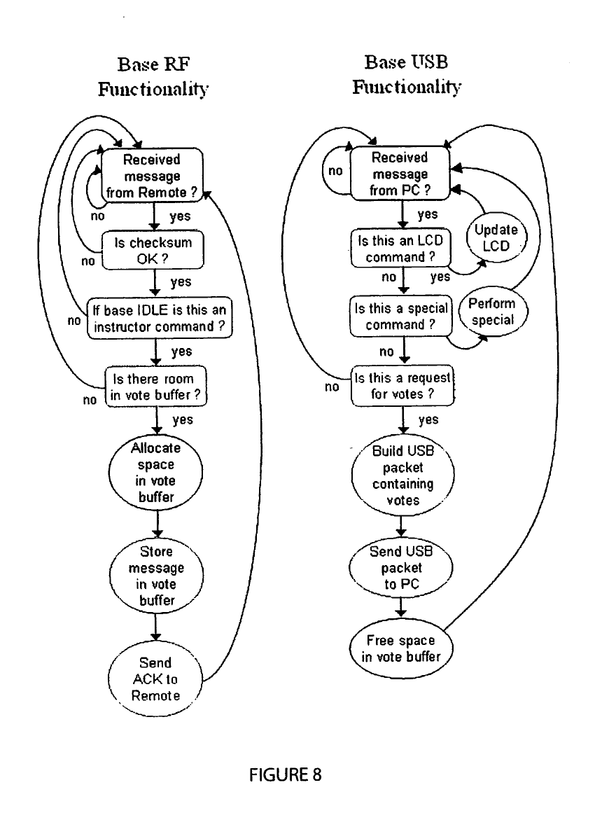

The functionality of the base unit 10 will now be described in more detail in conjunction with FIG. 8. The base unit 10 includes a communications port 21 for interfacing with a personal computer. Through the use of a software application, the computer is used to send commands to and control the functionality of the base unit. The base unit may also include a LCD screen or other such display devices for the visualization of status messages on the base unit 10.

When a base unit 10 is initially powered on, the base unit monitors the communications port 21 for commands from the computer. The software application can be used to instruct the base unit 10 to display a message on the LCD screen such as status, statistics, or voting results. The software application can also be used to instruct the base unit to perform special functions, such as to enter into an acquisition mode for receiving vote signal packets from remote units, change the operating frequency pair of the base unit, call for performance and error statistics, or reset the base unit. The base unit can also be instructed to transmit to the computer the voting results stored in the base unit memory. Voting results may be displayed on the LCD screen of the base unit and the computer via use of the software application.

The base unit can also be instructed by the software application to register the unique identification code of a remote unit as the master remote unit. Activation of response keys on the master remote unit are interpreted by the base unit as commands, which can be programmed to perform functions such as entering into acquisition mode, changing the computer display, advance slides in a slide presentation, or signal the base to deliver the stored voting results to the computer through the communications port 21.

When switched to acquisition mode, the base unit passively listens for voting signal packets sent by remote units operating on the matching frequency pair. When a packet is received by the base receiver 18, the integrity of the signal packet is evaluated with the checksum that is part of the signal packet. If the signal packet is valid, the base unit registers and stores the vote in a memory buffer and transmits an acknowledgment signal via the base transmitter 16 to the transmitting remote unit.

Communication in the audience response system described is initiated by the remote unit only after a response key is activated. Once a response key is activated, the remote unit attempts transmission of the vote signal packet to the base unit without waiting for the base unit to poll or otherwise communicate to the remote unit. The base unit's does not poll or otherwise transmit to the remote units other than an acknowledgment when the vote signal packet was successfully received.

The foregoing description and the drawings are illustrative of the present invention and are not to be taken as limiting. Still other variants and rearrangements of parts within the spirit and scope of the present invention are possible and will be readily apparent to those skilled in the art.

1-22. (canceled)

23. An audience response system comprising:
a plurality of transmitter units; and
a receiver unit, wherein each transmitter unit includes a unique address and logic programmed to perform the steps of receiving a user selection via a button push and, responsive to the button push, without receiving a signal from the receiver unit to initiate transmission, repeatedly transmitting a wireless selection signal until a wireless acknowledgment signal is received, the wireless selection signal including the unique address and the user selection, and wherein the receiver unit includes a receiver for receiving a wireless selection signal and logic programmed to transmit a wireless acknowledgment signal in response to the receipt of each wireless selection signal.

24. The audience response system of claim 23 wherein each transmitter unit includes a keypad.

25. A method for wirelessly communicating data from a plurality of transmitter units to a receiver, the method comprising the steps of:
receiving a user input at one of the plurality of transmitter units;
formatting a radio frequency signal comprising the user input and a unique identifier;
asynchronously repeatedly wirelessly transmitting the radio frequency signal;
wirelessly receiving an acknowledgment radio frequency signal comprising the unique identifier; and
terminating the step of asynchronously repeatedly wirelessly transmitting.

26. The method of claim 25, wherein the terminating occurs upon receiving the acknowledgment radio frequency signal.

27. The method of claim 25, wherein the step of terminating transmission of the wireless signal occurs after a predetermined interval.

28. The method of claim 25, further comprising a step of generating a transmission interval.

29. The method of claim 25, wherein the radio frequency signal and the acknowledgment radio frequency signal have different frequencies.

30. The audience response system of claim 23, wherein the receiver unit includes a display.

31. The audience response system of claim 30, wherein the display is a liquid crystal display.

32. The audience response system of claim 23, wherein each transmitter unit includes an output interface.

33. The audience response system of claim 32, wherein the output interface includes at least one LED.

34. The audience response system of claim 32, wherein the output interface includes a liquid crystal display.

35. A wireless remote unit for use in a system for communicating voting results between a plurality of remote units and a base unit, comprising:
a remote transmitter,
a remote processor configured to receive a vote, and in response, communicating instructions to the remote transmitter to transmit a vote signal packet assembling an identification code unique to the remote unit and the vote,
a status indicator to indicate whether an acknowledgment signal containing an identification code matching the identification code of the remote unit was received by the remote receiver within a predetermined period of time;
the remote processor configured to communicate instructions to the remote transmitter to initiate retransmission of the vote signal packet in response to the acknowledgment signal not being received within the predetermined period of time, with retransmission of the vote signal packet initiated after passing of a first time interval; and
the remote processor is further configured to communicate instructions to the remote transmitter to repeat retransmission of the vote signal packet after passing of a second time interval, in response to the acknowledgment signal not being received within a predetermined period of time following an initial retransmission.

36. The wireless remote unit according to claim 35 wherein the remote unit further comprises at least one counter.

37. The wireless remote unit according to claim 36 wherein the remote unit comprises a first counter and a second counter.

38. The wireless remote unit according to claim 37 wherein the first and the second time intervals are determined by operation of the first counter and the second counter, respectively.

39. The wireless remote unit according to claim 35 wherein the first counter and the second counter are initialized when the remote unit is powered on.

40. A wireless communication system comprising:
a plurality of remote units, comprising a remote transmitter, a remote processor configured to receive a vote and in response, to communicate instructions to the remote transmitter to transmit a vote signal packet assembling an identification code unique to the remote unit and the vote, a remote receiver, a status indicator to indicate whether an acknowledgment signal containing an identification code matching the identification code of the remote unit was received by the remote receiver within a predetermined period of time, the remote processor configured to communicate instructions to the remote transmitter to initiate retransmission of the vote signal packet in response to the acknowledgment signal not being received within the predetermined period of time;
a base unit adapted for wireless communication comprising a base receiver to receive the vote signal packet from the remote unit, a processor for registering the vote, and a base transmitter to transmit an acknowledgment signal to at least the remote unit sending the vote signal packet, the acknowledgment signal comprising the identification code unique to the remote unit from which the vote signal packet was received;
retransmission of the vote signal packet initiated after passing of a first time interval; and
the remote processor is configured to communicate instructions to the remote transmitter to repeat retransmission of the vote signal packet after passing of a second time interval, in response to the acknowledgment signal not being received within the predetermined period of time following an initial retransmission.

41. The wireless communication system according to claim 40 wherein the remote unit sending the vote signal packet, upon receiving the acknowledgment signal, powers down the remote transmitter.

42. The wireless communication system according to claim 40 wherein the remote unit comprises a first counter and a second counter.

43. The wireless communication system according to claim 40 wherein the first and the second counters control initiation of retransmission.

44. The wireless communication system according to claim 40 wherein the first and the second time intervals are determined by operation of the first counter and the second counter, respectively.

45. The wireless communication system according to claim 40 wherein the frequency of the remote transmitter is determined by a signal from the base unit and received by the remote receiver.

46. A method for wirelessly communicating to a base unit with a remote unit in an audience response system comprising the steps of:
activating a response key on a remote unit;
transmitting a vote signal packet from the remote unit to the base unit, the vote signal packet comprising an identification code unique to the remote unit and a message corresponding to the response key activated;
receiving, if available, an acknowledgment signal containing an identification code from the base unit; comparing the identification code in the acknowledgment signal with the identification code of the remote unit;
displaying on the remote unit a visual cue certifying that the vote signal packet was successfully received by the base unit if the identification code in the acknowledgment signal matches the identification code of the remote unit;
retransmitting the vote signal packet if an acknowledgment signal is not received from the base unit, said retransmitting delayed until a first predetermined time has elapsed following transmission of the vote packet signal; and
repeating retransmission of the vote signal packet if an acknowledgment signal is not received from the base unit upon an initial retransmission of the vote signal packet, said repeating transmission delayed until a second predetermined time has elapsed following initial retransmission of the vote signal packet.

47. The method of claim 46, further comprising the step of displaying on the remote unit a visual cue to indicate that the transmission of the vote signal packet was not received by the base unit.
